(19) United States
(12) Patent Application Publication
(10) Pub. No.: US 2009/0166394 A1
(43) Pub. Date: Jul. 2, 2009

(54) External Nailing Device Adaptor

(76) Inventor: Lawrence Gyorkos, Stetsonville, WI (US)

Correspondence Address: STEVEN H GREENFIELD, 4649 SEMINOLE TRAIL, GREEN BAY, WI, 54313, US

(21) Appl. No.: 11/968,647

(22) Filed: Jan. 2, 2008

(51) Int. Cl. B25C 7/00; B25C 1/04; B27F 7/09; B25C 1/00; B27F 7/02

(52) U.S. Cl. 227/142; 227/156; 29/525.11

(57) ABSTRACT

An external adaptor for a palm nailer is disclosed. The adaptor acts as a spacer and allows controlling the depth of the nail pounded into siding or tiles. The adaptor is fitted onto a stationary extension sleeve that protrudes from the nailer and is clamped onto it using at least two threaded fasteners. A method for attaching and setting up the adaptor is also disclosed. The adaptor is moved up or down the stationary sleeve and the location that provides the optimum nail depth is established by trial and error.

### FIELD OF THE INVENTION

The present invention relates to a palm nailer and more specifically to an external adaptor mounted on a nailer for controlling the depth of a nail penetration into construction materials for which an exact nail depth is important such as for siding.

### BACKGROUND OF THE INVENTION

Power nailers are useful tools in the installation of roofing tiles and siding for homes that require driving multiple nails in a short period of time. They perform the nailing work considerable faster and with greater ease compared to manual hammering. Nailers come in a variety of designs and sizes. The most common type of power nailer is a pneumatic nailer powered by air pressure typically from a compressor. Another common power nailer is a nail gun used for multiple nailings. Nail guns can be loaded with as many as 300 nails and are typically equipped with a trigger for driving the nails in a succession.

A type of nailer used for individual nails is a palm nailer. It usually does not have a trigger and fires only one nail at a time. The main benefits of palm nailers are their low weight and their ability to fit into tight places because of their relatively small size.

A typical design of the present art palm nailer is illustrated in FIGS. 1, 1a, 2 and 2a. Air pressure to the nailer is supplied through an air hose attached to a connector 6. The nail 9 is placed inside the guide box 8. Pounding the nail 9 into a surface 10 is accomplished by placing the head of the nail against the hammering piston 11, positioning the tip of the nail 9 onto the desired spot of the tile or siding surface 10 and applying light pressure from the palm in the direction of the nail travel. The palm pressure triggers a repeated hammering action of multiple hits per second by the hammering piston 11. As the nail 9 is hammered into the desired spot, the nailer guide box 8 is pressed against the siding or tile surface 10. This pressure causes the guide box 8 to retract into stationary extension sleeve 7 and to compress the spring 12 against which it rests. Once the guide box 8 fully retracts, and the extension sleeve 7 reaches the surface 10, the user may back off the nailer 3 as the nail 9 has been fully driven in. The nailer 3 shuts off when the nail 9 reaches the maximum depth or when the nailer 3 is backed off the surface 10 and pressure is removed. When this occurs, the guide box 8 springs forward to its original position.

A significant disadvantage of pneumatic nailers is their inability to control the depth of nail penetration. Pneumatic nailers are designed to drive the nail flush with the wall. In several situations, most notably with nailing vinyl siding and some types of tiles, it is desirable to have a small gap between the nail and the surface of the siding to allow the siding to expand and contract with the changing outside temperatures without buckling, cracking and warping. Driving the nail too deep into the siding tends to inhibit the expansion and contraction of vinyl siding. Also, the pounding that is applied onto the vinyl siding by the piston hammering action can cause damage to the siding.

A variety of attachments and spacers are disclosed in the prior art for controlling nailing depth. U.S. Pat. No. 5,405,071 relates to a removable device having an easy to use, finger-adjustable design for readily varying the penetration depth of nails exiting from a pneumatic nail gun. It includes a cylindrically-shaped base member configured for coupling to the push lever of a nail gun, and a cylindrically-shaped adjustment knob that is threaded to the base member. The adjustment knob can be coupled directly to the firing head of a nail gun not having a push lever. U.S. Pat. No. 5,743,455 is for an adapter for a fastener (generic word for nails) driving tool for controlling depth penetration of a fastener fired from the tool, comprising a lip portion adapted for attachment to a firing portion of the fastener driving tool and extending downward from the firing portion and substantially across to form a recess. The recess, in corresponding alignment with the firing portions engages the fastener when the fastener is fired from the fastener driving tool to allow for spacing between the fastener and material. U.S. Pat. No. 6,393,711 discloses a gauging tool for attachment to a fastener gun which dispenses fasteners, which in this case is a generic word for nails. The gauging tool includes a positioning shoulder that is placed against the shoulder of siding that is to be secured to the wall of a building. The siding includes an attaching lip through which fasteners are driven for fastening the siding to the wall. The gauging tool of the present invention automatically positions the fastener a selected distance from the shoulder of the siding and automatically drives the fastener a selected depth into the wall. U.S. Pat. No. 6,695,192 is directed to a fastener driving tool having a depth of drive control. The fastener driving tool includes a tool body having a cylinder with an axis, wherein the cylinder encloses a piston, and wherein the piston is driven in a driving direction, a depth control probe, and a bumper associated with the depth control probe, the bumper having a trailing surface, wherein the depth control probe is movable with respect to the tool body between an extended position and a retracted position. U.S. Pat. No. 6,824,036 also teaches an adapter attached to a fastener driving tool for installing siding on a structure. The adapter has a front face and a back face with an opening formed there between. A cavity is formed in the back face and a face plate of the fastener driving tool is received in the cavity. The adapter comprises a jaw on the front face of the adapter. U.S. Pat. No. 6,883,696 discloses a depth adjustment assembly that includes a stem, a sleeve that is coupled to the stem, and a knob. The knob is coupled to the sleeve and is axially movable. U.S. Pat. No. 7,066,371 refers to a nail gun and depth control spacer assembly for ejecting nails into a substrate which contains two or more layers of roofing materials one of which is a compressible fibrous layer. The nails penetrate the substrate but are prevented by the depth control spacer from permanently compressing the compressible fibrous layer which springs back to its original thickness after completion of the nailing process. The depth control spacer, attached to the base of the nail gun, is of semi-oval configuration having a pressure sensitive layer and a solid layer, is provided with an oval cavity in its center portion through which the nails are ejected into the substrate. Pre-grant publication 20070057009 relates to an attachment for a palm nailer that allows the palm nailer to be used for planishing metal. A cylindrical portion with a threaded end is attached to a palm nailer through a receiving end, and a head piece suitable for planishing metal is secured to the threaded end. In Pre-grant publication 20070199970, the nailing depth control structure for a palm nailer is mounted at the hammering head of the palm nailer. The control structure includes a control block with several steps, a cylinder base, a flexible pipe fitted internally with an anchoring position, a resilient component and a rotary location component. When the user employs the present invention, it is possible to drive the synchronous rotation of flexible pipe and change the position of anchoring position of flexible pipe in relation to steps of control block, thereby adjusting retracted distance of flexible pipe for easy control of nailing depth. By using scale markers placed externally at the cylinder base, it is feasible to identify the current nailing depth of palm nailer, and relieve the need of removing structural components with improved efficiency and ease-of-operation.

The attachments, spacers, and modifications to the nailer design disclosed in the prior art establish a specific nail depth. Changing the nail depth typically requires changing the spacer or attachment.

### SUMMARY OF THE INVENTION

The present invention relates to an external adaptor that is mounted onto a pneumatic palm nailer for controlling nailing depth. The adaptor 15, illustrated in FIGS. 3-5 and shown mounted onto the nailer in FIG. 6, is cylindrical in shape and is secured onto the outside of the extension sleeve 7 that protrudes from the nailer body 3 as shown in FIG. 1. Securing the adaptor 15 is accomplished by at least two threaded fasteners which tightly grip onto the extension sleeve 7.

It is the object of the present invention to provide an adaptor to a palm nailer that allows varying the depth of nail penetration into the surface of a wall, tile or siding with relative ease. It is also the object of the present invention to provide a nailer that is suitable for a wide variety of nailer types and styles. It is further the object of the present invention to provide an external device for use with a pneumatic palm nailer to control nailing depth that is easy to install and to adjust as needed for use with a wide variety of siding types and materials.

### BRIEF DESCRIPTION OF THE DRAWINGS

FIG. 1 is an outer side view of a typical nailer of the prior art.

FIG. 1a is an elevation view of the outer top and side of another typical prior art nailer.

FIG. 2 shows the key components of the nailer of the prior art.

FIG. 2a is a cross sectional front side view of a typical palm nailer of the prior art showing the configuration of the inner parts.

FIG. 3 illustrates the outer side and top part of the adaptor.

FIG. 4 is a perspective view of the top part of the adaptor.

FIG. 5 is a perspective view of the inside part of the adaptor from the bottom side.

FIG. 6 shows the adaptor mounted on the nailer of the prior art.

FIG. 6a is a cross sectional front view of a typical palm nailer of the prior art onto which the adaptor is mounted showing the inner configuration of the nailer and the adaptor.

FIG. 6b is a cross sectional side view the side of a typical palm nailer of the prior art onto which the adaptor is mounted showing the inner configuration of the nailer and the adaptor.

FIG. 7 illustrates an alternate embodiment of the palm nailer adaptor system having an added safety feature; a lanyard threaded on one side through the head of a permanent cap screw that replaces one of the adaptor's set screws, and loops around the air hose connector on the other side.

FIG. 8 shows the cap screw of FIG. 7 having a channel drilled through the cap and having the lanyard threaded through the channel. The cap screw is attached to the adaptor by threading onto a hex socket.

FIG. 9 shows the dimensions of the preferred embodiment of the present invention.

### DETAILED DESCRIPTION OF THE INVENTION

The preferred fasteners for the adaptor of the present invention are set screws, and in the preferred embodiment of the present invention, four set screws spaced evenly across the circumference of the adaptor are used. To tighten or loosen the set screws, an Allen wrench is typically used. It should be understood, however, that other means of fastening the adaptor, such as combinations of bolts, nuts, thumb screws, and washers, are also within the scope of the present invention. It should also be understood that, while the adaptor of the present invention is particularly suitable for a palm nailer, said adaptor may be used with other types and styles of nailers. The preferred material of construction of the adaptor is carbon steel. However, a variety of carbon steel alloys, including cast iron and cast steel, stainless steel including ferritic, martensitic, and austenitic stainless steels, aluminum, brass, bronze, titanium, and plastic materials, including injection molding polymers, are also within the scope of this invention.

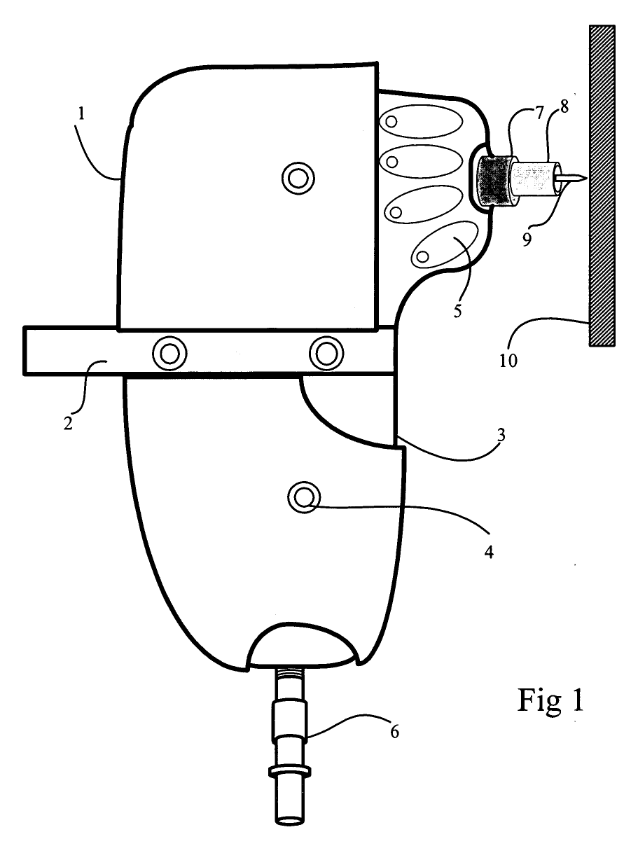

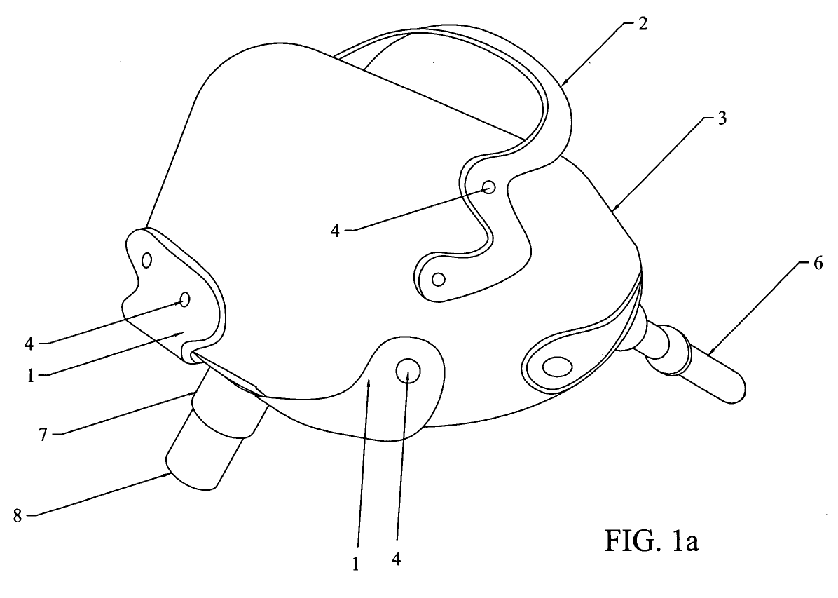

The adaptor functions as a spacer that reduces the distance the nailer guide box 8 retracts into the extension sleeve 7 as referred to in FIG. 1. When the adaptor is installed, the top side of the adaptor reaches the surface of the wall or siding before the nail is fully driven in, signaling the user to stop and back off. To achieve the desired nail penetration depth, the proper position of the adaptor on the extension sleeve 7 must be established. This is accomplished by trial and error. An initial test is conducted on the siding that requires nailing. If the test indicates that nail penetration is too deep, the set screws are loosened and the adaptor is raised slightly. The set screws are then retightened. If, on the other hand, the siding was not nailed tightly enough, the adaptor is lowered. The process is repeated until the proper position for the adaptor is established. Once established, this position should work well for nailing the same type of siding or tiles in the future to complete the job. This position will depend greatly on the type of siding used, however, and will likely need to be readjusted for different siding types, materials and thicknesses.

The adaptor of the present invention is a cylinder having a height, an outside diameter and an inside diameter that is smaller than the outside diameter and thus defines a wall thickness. The adaptor cylinder is also characterized by a top side, a bottom side, an outside surface and an inside surface. The top side of the adaptor is closest to the guide box, while the bottom is close to or touches the body of the nailer. The adaptor inside diameter is designed to fit over the outside diameter of the extension sleeve for most palm nailer models. In the preferred embodiment of the present invention, the top inside part of the adaptor has an extension lip which reduces the top inside diameter compared to the bottom inside diameter. When the adaptor is mounted onto the nailer, the extension lip rests against the top of the extension sleeve of the nailer.

The adaptor is initially mounted such that the extension lip rests against the top of the nailer extension sleeve. In this position, the top of the adaptor is almost flush with the top of the extension sleeve and is still too far back to have much effect on nailing depth. Thus, with this positioning of the adaptor, the nailer will still generally pound the nails in too far. As the adaptor is raised, nailing depth is gradually reduced until the desired depth is reached.

The set screws are installed into set screw sockets inserted into holes drilled through the thickness of the adaptor walls. They are adapted to allow tightening from the outside in.

In another embodiment of the present invention, a safety device is added to the adaptor to prevent it from accidentally falling off the nailer and potentially injuring a passerby or another worker. Such a circumstance may arise if the nailer is used in construction work on a roof or a high rise building. The safety device comprises of a lanyard having two end loops. The device attaches to the adaptor at the first end loop and secured to the nailer air hose connector at the second end loop. In order to attach the lanyard to the adaptor, one of the set screw sockets is replaced by a hex socket and the set screw is replaced by a cap screw. A channel is drilled through the screw cap and the first end loop of the lanyard is threaded through the channel. The second end loop is looped around the nailer air hose connector. In the preferred embodiment of the safety device, the lanyard is made of 3/64″ braided stainless steel wire. However, other materials comprising of a variety of steel, copper, aluminum and iron alloys as well as nylons, plastics and other synthetic materials also fall within the scope of this invention.

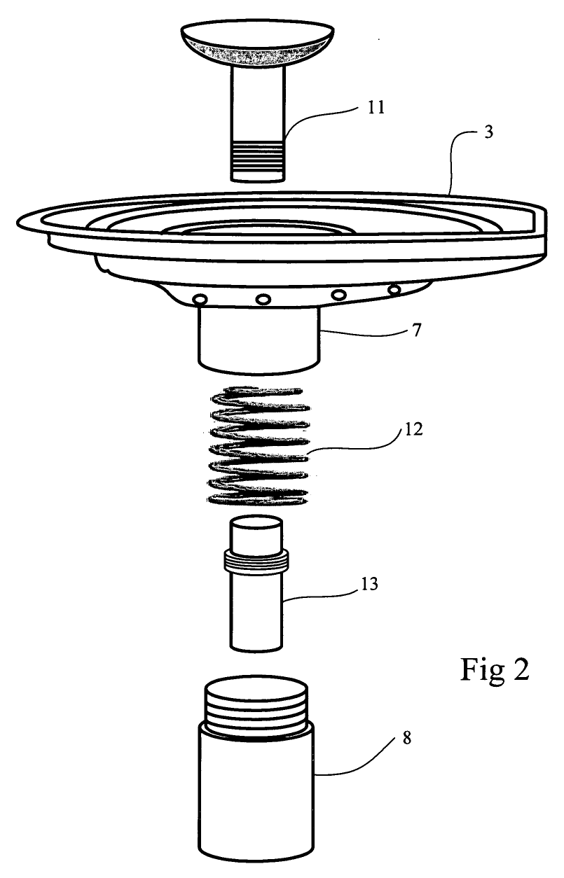

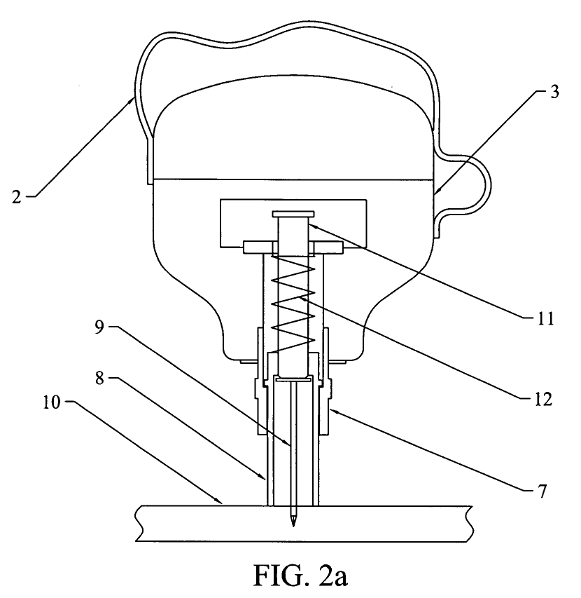

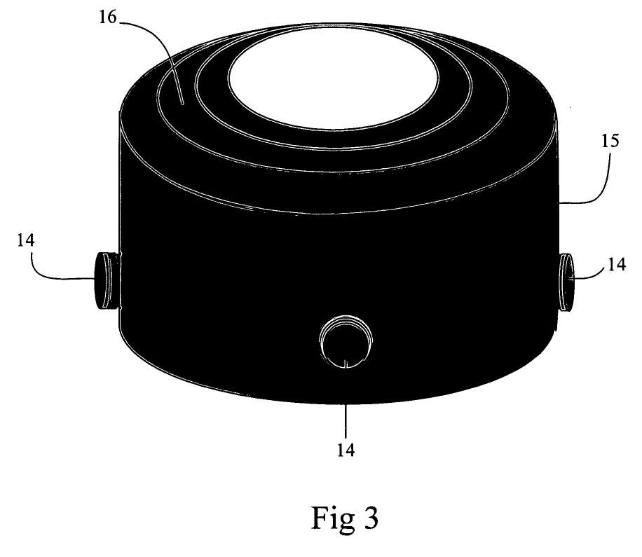

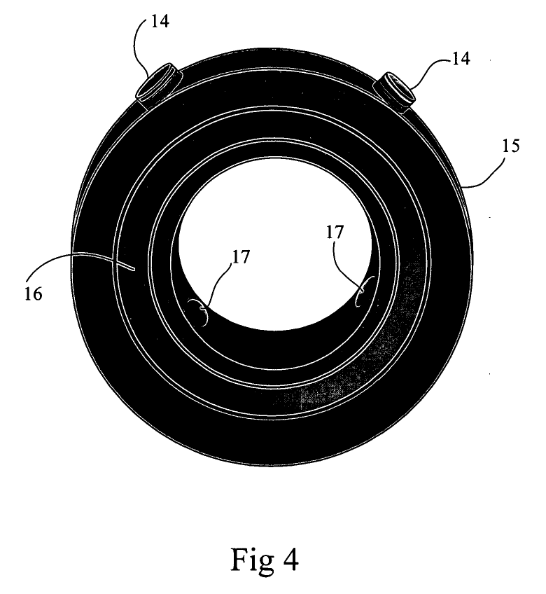

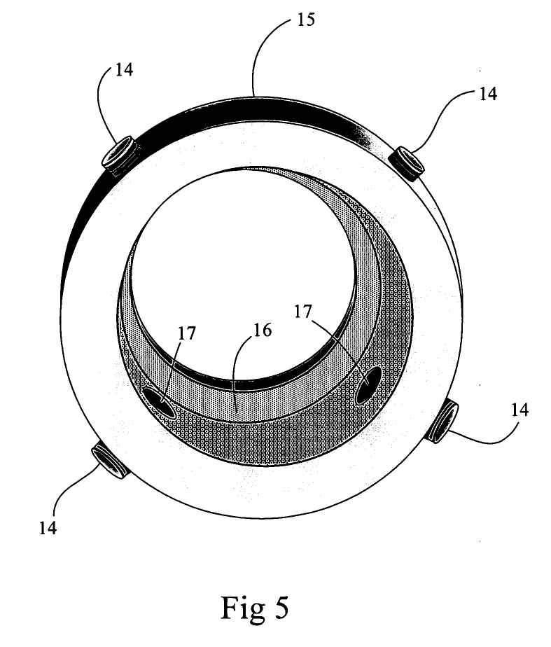

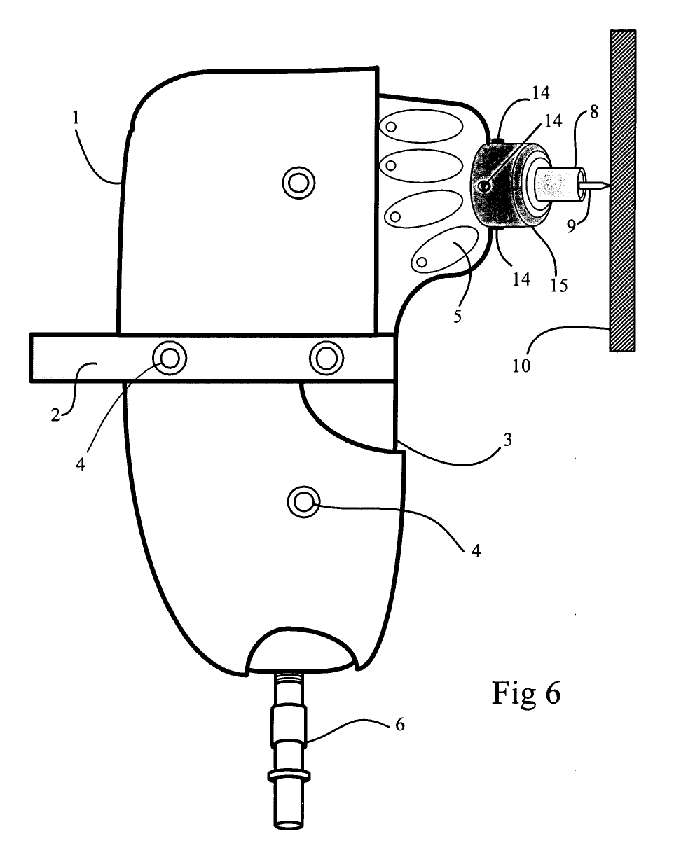

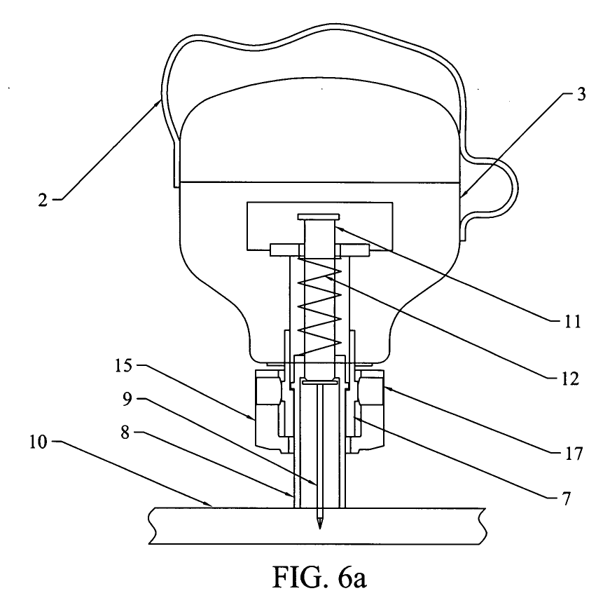

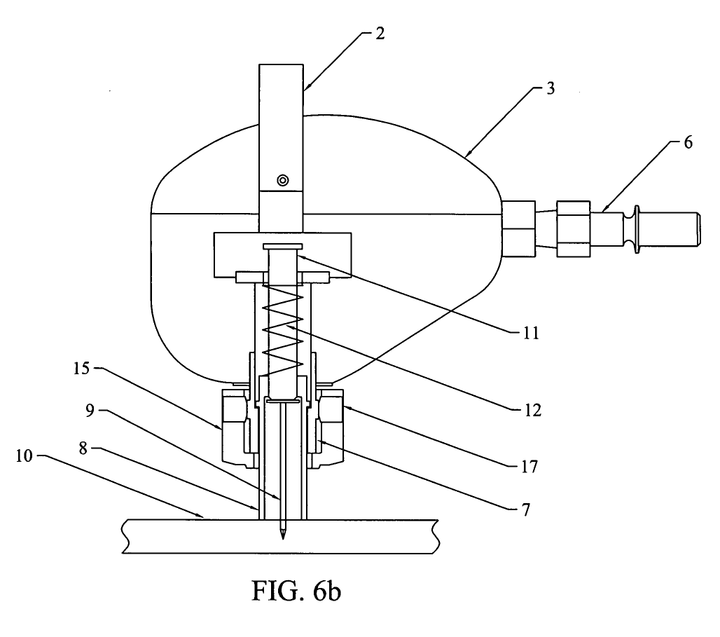

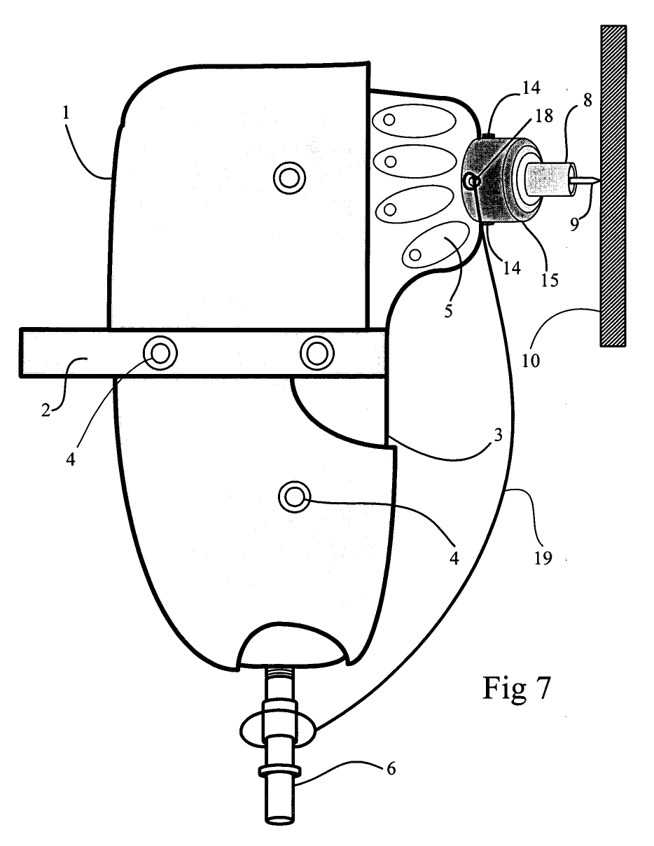

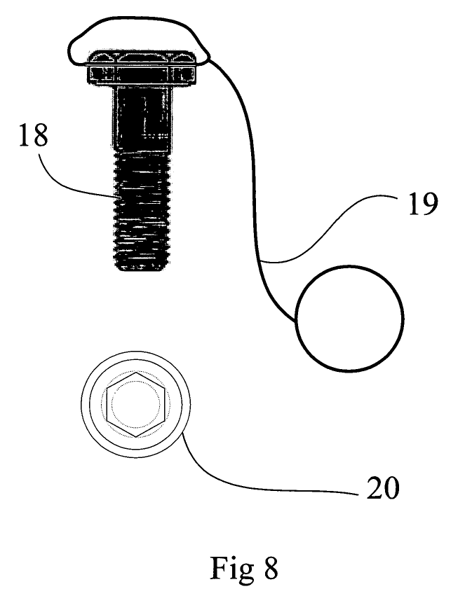

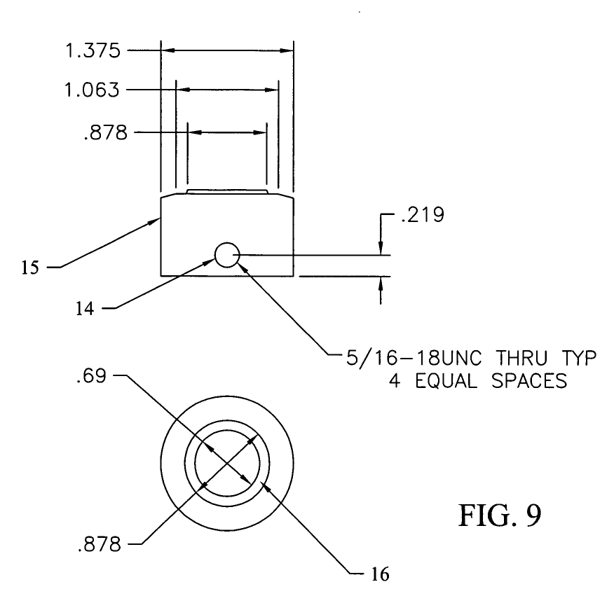

Referring to FIG. 1 and FIG. 1a, palm nailer 3 is partially wrapped with a cover 1 attached to the nailer body 3 by snaps 4, and a strap 2 for attaching the nailer 3 to the palm of the hand. The cover 1 is made of fabric, plastic, or leather and is wrapped around the nailer 3 by snaps 4. The cover 1 also has a strap 2 for carrying the nailer 3 and for inserting the user's hand to make operating the nailer 3 more user-friendly. The front part of the nailer body 3 close to the guide box 8 has several depressions 5 used for exhausting any excess air pressure. A connector 6 for an air hose is used for providing air pressure to activate the nailer 3. An extension sleeve 7 protrudes out of the nailer body 3. The extension sleeve 7 houses the guide box 8 as it retracts in the process of pounding a nail 9 into siding or wall 10. FIGS. 2 and 2a show the key components of the nailer required for proper functioning. The hammering piston 11 is activated by air pressure causing it to vibrate against the head of the nail 9 and pressing it into the surface of the siding or tile 10. The hammering action is controlled by the guiding tip 13 and palm pressure against the nailer 3. The guide box 8 that contains the nail retracts into the extension sleeve 7 when pressed against the surface of the siding and compresses a spring 12 located behind it. When the nail 9 is driven in and the nailer 3 is backed away from the surface of the wall or siding 10, the spring 12 pushes back against the guide box 8 which then resumes its original position. FIG. 3 exhibits three of the four set screws 14 evenly distributed across the perimeter of the adaptor outside surface 15. The top inside diameter is reduced by the extension lip 16. FIG. 4 shows two of the four set screws 14 protruding from the outside surface of the adaptor 15. Two of the four holes 17 drilled in the adaptor wall for the set screws are displayed on the inside surface. All four set screws 14 are shown in FIG. 5 on the outside surface of the adaptor 15 as are two of the holes drilled in the adaptor wall 17 for the set screws shown on the inside. Also illustrated in FIG. 5 is the inside of the extension lip 16. FIG. 6 shows the adaptor 15 mounted on a typical palm nailer 3 having all the components illustrated in FIG. 1. Three of the four set screws 14 are depicted on the adaptor outside surface 15. The nailer 3 pounds a nail 9 into a wall or siding surface 10. FIGS. 6a and 6b portray the sectioned adaptor 15 mounted on the nailer 3 of FIG. 2a in a frontal and in a side position showing two of the holes 17 drilled in the adaptor wall for installing the set screws. FIG. 7 shows the installed adaptor 15 onto the nailer 3 as in FIG. 6 but with the addition of a lanyard 19 attached to the adaptor 15 at one end, and looping around the air hose connector 6 at the other end. The attachment of the lanyard 19 to the adaptor is accomplished by replacing one of the set screws by a cap screw 18, drilling a channel through the screw cap, and threading one end of the lanyard through the screw cap channel. FIG. 8 depicts the cap screw 18 with the channel going through the cap and the lanyard 19 threaded through the channel. The cap screw 18 threads into a hex socket of an appropriate size. The hex socket replaces one of the set screw sockets in the adaptor 15. FIG. 9 indicates the dimensions of the adaptor preferred embodiment.

In the preferred embodiment of the present invention, the outside diameter of the adaptor 15 is about 1.37″, the wall thickness is about 0.3″ and the extension lip 16 has a radius of about 0.26″. The inside diameter at the top of the adaptor is about 0.8″, and the center of the holes for the set screws 14 are drilled about 0.22″ from the bottom side of the adaptor 15, and the screws 14 have about a 5/16″ thread. The height of the adaptor, i.e., the distance from the bottom to the top side is about 0.89″. The top side of the adaptor 15 has a slight upward pitch of about 0.06″. The up and down distance the adaptor 15 can be adjusted on the extension sleeve is about 0.65″.

I claim:

1. A cylindrical apparatus for adapting and mounting onto a nailing device comprising a cylindrical main body having an open top and an open bottom, said cylindrical main body comprising of a top part, a bottom part, an inside surface and an outside surface, an outside diameter and an inside diameter, the difference between said outside diameter and inside diameter defining a wall thickness, said apparatus comprising at least two threaded fasteners for securing the apparatus onto the nailing device, said threaded fasteners being threaded into sockets, said sockets being inserted into holes drilled through the wall thickness of the apparatus, said threaded fasteners adapted for fastening from the outside to the inside, said threaded fasteners being evenly spaced across the circumference of the cylinder.

2. The apparatus of claim 1, in which the nailing device comprises a cylindrical stationary extension sleeve, said extension sleeve having an outside diameter, said extension sleeve also having a top side and a bottom side, said top side of said extension sleeve protrudes out from the nailing device, said nailing device also comprises a cylindrical guide box for holding and guiding a nail, said guide box having an outside diameter, said guide box also having a top side and bottom side, said top side of said guide box protrudes out from the extension sleeve, said bottom side of the guide box being in contact with a compressible spring inside the nailing device.

3. The apparatus of claim 2, wherein said nailing device further comprises an air hose connector, said air hose being connected to a compressor for pneumatically powering said nailing device.

4. The apparatus of claim 3, wherein the threaded fasteners fasten onto the extension sleeve of said nailing device.

5. The apparatus of claim 4, wherein the top inside surface of said apparatus further contains a circular extension lip that protrudes toward the inside of said apparatus, said circular extension lip defining an inside diameter at the top of the cylindrical apparatus that is smaller than the inside diameter at the bottom of said cylindrical apparatus, said bottom inside diameter of said cylindrical apparatus substantially matches the outside diameter of the nailing device extension sleeve, said top inside diameter of said cylindrical apparatus substantially matches the outside diameter of the nailing device guide box.

6. The apparatus of claim 5, in which the threaded fasteners are set screws.

7. The apparatus of claim 6, wherein the number of set screws is four.

8. The apparatus of claim 7, wherein the cylindrical apparatus is used for controlling the depth of a nail penetration into construction materials wherein an exact nail depth is important.

9. The apparatus of claim 8, wherein said construction materials comprise siding.

10. The apparatus of claim 9, wherein the siding is vinyl siding.

11. The apparatus of claim 4, wherein a hex socket is fitted into one hole drilled in the apparatus and one threaded fastener is a cap screw of a size corresponding to the hex socket, said cap screw having a cap and a threading member, said threading member is threaded into the said hex socket, said cap having a channel drilled through the cap of said screw cap.

12. The apparatus of claim 11, further comprising a lanyard having a first loop at one end and having a second loop on another end, said first loop of said lanyard is threaded through said channel, said second loop is looped around the air hose connector.

13. A method for attaching and setting up the apparatus of claim 10 for proper operation comprising the steps of
inserting the top side of the guide box through the bottom side of the apparatus;
placing the apparatus onto the extension sleeve of the nailing device, said circular extension lip resting against the top of the extension sleeve;
tightening the threaded fasteners from the outside of the apparatus toward the inside sufficiently tightly to prevent slippage under normal operating conditions;
if the number of threaded fasteners is four or larger, the fastener that is tightened next is that diagonally opposite the previous one;
driving one nail through the siding surface using the nailing device and determining the depth of the nail;
if the nail was pounded in too deeply, loosening the threaded fasteners of the apparatus and sliding the apparatus toward the top of the guide box;
retightening the threaded fasteners;
driving in another nail and checking the depth of the nail;
if the nail was pounded in too deeply, loosening the threaded fasteners of the apparatus, and sliding the apparatus toward the top of the guide box, then retightening the threaded fasteners; and
if the nail was pounded in too loosely, loosening the threaded fasteners of the apparatus and sliding the apparatus toward the bottom of the guide box, then retightening the threaded fasteners.

14. The method of claim 13, further comprising repeating said steps as needed until the desired nail depth is achieved.
